(19) United States
(12) Patent Application Publication
(10) Pub. No.: US 2007/0276073 A1
(43) Pub. Date: Nov. 29, 2007

(54) Ultrafine Natural Ground Brucite

(76) Inventors: Cesar Agra-Gutierrez, Cornwall (GB); Mark Windebank, Cornwall (GB); Scott Palm, Alpharetta, GA (US); David Skuse, Cornwall (GB); Fu-Jya Daniel Tsai, Alpharetta, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/588,438

(22) PCT Filed: Feb. 4, 2005
(86) PCT No.: PCT/GB05/00388

§ 371 Date: Jul. 20, 2007

(30) Foreign Application Priority Data
Feb. 6, 2004 (GB) 0402627.4

(51) Int. Cl. C01F 5/14; C08K 3/22; H01B 7/295

(52) U.S. Cl. 524/436; 423/155; 423/161; 423/635

(57) ABSTRACT

The invention provides particulate natural magnesium hydroxide (e.g. brucite) having a d₉₀ less than or equal to 6.2 μm, as measured by CILAS, and a particulate filler material for use in a polymeric composition, particularly but not exclusively a flame-retardant polymeric composition, the filler material comprising the particulate natural magnesium hydroxide and optionally one or more other particulate inorganic material (e.g. alumina trihydrate).

### FIELD OF THE INVENTION

The present invention relates to particulate natural magnesium hydroxide, also know as brucite, to a method for the production thereof, and to compositions, particularly but not exclusively flame-retardant polymeric compositions, including the same as a filler.

### BACKGROUND OF THE INVENTION

It is known that a particulate magnesium hydroxide filler material can impart flame retardancy and self-extinguishing characteristics in polymeric compositions such as plastics for use in electrical cable insulation and the like.

It is generally desirable that magnesium hydroxide for use in polymer compositions have a fine particle size. This is because the polymer mechanical properties, such as tensile and flexural strength, can be affected by the particle size of additives incorporated within the polymer. It is believed that coarse filler particles can serve as sites for the generation of cracks that can reduce the impact strength of the polymer (see e.g., ‘Toughening of Polypropylene by CaCO₃: Effect of Particle Size and Surface Caoting’, D. A. Taylor and C. D. Paynter, Polymat 1994—Toughening of Plastics III. Conference Proceedings, London, 19-22 September 1994, p. 628-38). As a result, it is desirable to use a fine magnesium hydroxide that has a relatively stringent top size, that is to say one that contains very few large particles.

Synthetic particulate magnesium hydroxide can be made at very fine particle sizes, but can be too expensive for use in many plastic products. Accordingly, the less expensive natural magnesium hydroxide, brucite, would be a potentially attractive alternative if it could be produced at the desired level of fineness. However, the inventors are unaware of any successful attempts to produce ground natural brucite having a suitable particle size distribution either through either dry or wet grinding techniques.

In Japanese Patent Application No. JP-01-294792 (Kokai), the disclosure of which is incorporated herein by reference, a process for the production of particulate natural magnesium hydroxide is described, in which natural brucite is said to be wet-ground so as to obtain an average particle diameter of between 2 and 6 μm, and then surface-treated with a fatty acid ammonium salt, and eventually dried.

In Japanese Patent Application No. JP-03-231944 (Kokai), the disclosure of which is incorporated herein by reference, a polymeric composition is described, containing particulate magnesium hydroxide having an average particle diameter of between 3 and 13 μm, said to be useful as a flame-retardant polymer.

In U.S. Pat. No. 6,552,112, the disclosure of which is incorporated herein by reference, a flame retardant cable is described, in which the polymer composition of the cable comprises a mixture of certain defined propylene and ethylene polymers and the filler is a flame-retarding amount of a particulate natural magnesium hydroxide, which may optionally be surface-treated as described therein. It is stated that the particulate natural magnesium hydroxide may be prepared by known wet or dry grinding, to provide a product having a specific surface generally between 5 and 20 m²/g, preferably between 6 and 15 m²/g, which can then be classified, for example by sieving, to obtain an average particle diameter of generally between 1 and 15 μm, preferably between 1.5 and 5 μm, and a particle size distribution such that not more than 10% of the total number of particles have a diameter lower than 1.5 μm, and not more than 10% of the total number of particles have a diameter greater than 20 μl.

However, the specific Examples provided in U.S. Pat. No. 6,552,112 are all considerably coarser than those claimed in the present invention. The finest products presented are the commercial products Hydrofy GS-1.5 and Hydrofy G-2.5 (from SIMA) are used, which are stated (Table I) to have an average particle diameter (d₅₀) of 2.1 and 2.6 μ/m respectively, a d₉₀ of 6.4 and 9.8 respectively and a specific surface of 10.4 and 8.2 m²/g respectively. There is no indication that products having an average particle diameter finer than 2.1 μm were ever actually produced. To the present inventors' knowledge, it is unlikely that sieving could actually be used commercially to produce finer products. The finest screens typically used for sieving are 325 to 400 mesh (˜20 micron (μm) opening size). Use of finer screens would be expected to result in clogging or a very low throughput.

EP-A-1043733, the disclosure of which is incorporated herein by reference, describes another flame retardant cable composition based on a mixture of certain defined propylene and ethylene polymers and, as filler, a flame-retarding amount of a particulate natural magnesium hydroxide. The characteristics of the filler appear to be generally similar to that described in U.S. Pat. No. 6,552,112.

In U.S. Pat. No. 6,252,173, the disclosure of which is incorporated herein by reference, a flame retardant non-aqueous organic polymer composition is described, which contains a flame-retardant amount of bauxite or brucite filler. It is stated that the bauxite or brucite may be prepared by grinding of the ore to the desired particle size, for example a preferred “median” particle size in the range of 0.3 to 5.0 μm, and a preferred surface area of greater than 10 m²/g. In the specific Examples, however, brucites having (Example 4) a “D50” of 11 μm and a surface area of 7.3 m²/g, and (Example 5) a “D₅₀” of 10.96 μm and a surface area of 7.38 m²/g were stated to be used in preparing cable formulations based on ethylene vinyl acetate (Examples 4, 5) or polyvinyl chloride (Example 6). Assuming that these size characteristics correspond to the statement of the preferred “median” particle sizes, these brucites are outside the preferred range stated.

In a surprising and unexpected result, the inventors have discovered that natural ground brucite with superior control of the top size of the material (as measured by d₉₀ and d₉₉) can be produced through the application of a particular wet attrition grinding method.

### BRIEF DESCRIPTION OF THE INVENTION

According to a first aspect of the present invention, there is provided particulate natural magnesium hydroxide having a d₉₀ less than or equal to 6.2 μm as measured by laser light scattering using a CILAS instrument.

The parameter d₉₀ as measured by CILAS is the particle equivalent spherical diameter (esd), as measured on the CILAS (Compagnie Industrielle de Lasers) 1064 or corresponding instrument, at which there are 90% by volume of the particles which have an esd less than the d₉₀ value.

According to a second aspect of the present invention, there is provided particulate natural magnesium hydroxide having a d₉₉ less than or equal to 20 μm as measured by CILAS.

The parameter d₉₉ as measured by CILAS is the particle equivalent spherical diameter (esd), as measured on the CILAS (Compagnie Industrielle de Lasers) 1064 or corresponding instrument, at which there are 99% by volume of the particles which have an esd less than the d₉₉ value.

According to a third aspect of the present invention, there is provided particulate natural magnesium hydroxide having a d₅₀ less than or equal to 2.0 μm as measured by CILAS.

The parameter d₅₀ as measured by CILAS is the mean or average particle equivalent spherical diameter (esd), as measured on the CILAS (Compagnie Industrielle de Lasers) 1064 or corresponding instrument, that is to say, the esd at which there are 50% by volume of the particles which have an esd less than the d₅₀ value. It should be noted that the expression d₅₀ used in the description of the present invention refers to a mean or average particle diameter, and not a median.

The particulate natural magnesium hydroxide may be present with one or more other particulate inorganic material. The mean particle diameter of the one or more other particulate inorganic material may be within the size ranges described above for the particulate natural magnesium hydroxide.

According to a fourth aspect of the present invention, there is provided a particulate filler material for use in a polymeric composition, the filler material comprising the particulate natural magnesium hydroxide according to the first, second or third aspect of the present invention and optionally one or more other particulate inorganic material.

The filler is preferably provided for use in the form of a substantially dry powder.

The particulate filler material may suitably consist essentially of the particulate natural magnesium hydroxide according to the first, second or third aspect of the present invention and one or more other particulate inorganic material.

The particulate natural magnesium hydroxide is preferably obtained by a wet attrition grinding process in which brucite is ground in an aqueous suspension in the presence of a grinding medium under conditions such that the energy input is in excess of about 20 kWh/tonne. The aqueous suspension may suitably contain dispersants and other conventional additives as desired. This process constitutes a fifth aspect of the present invention.

The one or more other particulate material may suitably have flame retardant properties and be present with the particulate natural magnesium hydroxide in a flame-retardant amount.

According to a sixth aspect of the present invention, therefore, there is provided a polymeric composition comprising a polymer and the filler material according to the first, second, third or fourth aspects of the present invention. The filler may suitably be present in an amount of between about 1% and about 90%, for example between about 10% and about 90%, by weight of the polymer.

The filler is preferably present in the polymer in a flame retarding amount, to provide a flame-retardant polymeric composition suitable, for example, for use as a sheath, coating or housing for an electrical product.

According to a seventh aspect of the present invention, there is provided a process for the preparation of the polymeric composition according to the sixth aspect of the present invention, which comprises mixing the components of the composition, the polymer component being present for the mixing as liquid or particulate solid, optionally an one or more precursor of the polymer.

According to an eighth aspect of the present invention, there is provided a mixture of a particulate filler material according to the fourth aspect of the present invention and a polymer or a precursor thereof in the form of a liquid or particulate solid.

According to a ninth aspect of the present invention, there is provided an article formed from a flame-retardant polymer composition according to the sixth aspect of the present invention.

According to a tenth aspect of the present invention, there is provided a sheath, coating or housing for an electrical product, for example a sheath component of an electrical cable, formed from a flame-retardant polymeric composition according to the sixth aspect of the present invention.

### DETAILED DESCRIPTION OF THE INVENTION

Natural Magnesium Hydroxide

The particulate natural magnesium hydroxide for use as a filler material according to the present invention is preferably prepared from coarsely comminuted brucite. Brucite may occur in substantially pure form or, more commonly, may be found in combination with other minerals such as calcite, aragonite, talc or magnesite, often in stratified form between silicate deposits, in chlorite, or in schists. The term “natural magnesium hydroxide” used herein includes all forms and occurrences of brucite, and processed (e.g. comminuted) derivatives thereof.

The term “particle diameter” used herein refers to a particle size measurement as determined by laser light particle size analysis using a CILAS (Compagnie Industrielle des Lasers) 1064 instrument. The CILAS instrument determines the particle size distribution of a sample by passing a laser beam through a dilute suspension of sample particles and measuring the resultant diffraction pattern of the laser beam. The diffraction pattern is then analyzed using mathematical algorythms based on optical theory to calculate the particle size distribution of the sample. The CILAS 1064 instrument used in the Examples herein was equipped with a wet sampling device and dual laser detection system to allow accurate measurement of very fine particles. The CILAS 1064 instrument normally provides particle size data to two decimal places.

The value of d₉₀ for the particulate natural magnesium hydroxide according to the first aspect of the present invention is less than or equal to 6.2 μm, for example less than or equal to about 6.0 μm, for example less than or equal to about 5.5 μm, for example less than or equal to about 5.0 μm, for example less than or equal to about 4.5 μm, for example less than or equal to about 4.0 μm, for example less than or equal to about 3.5 μm, for example less than or equal to about 3.0 μm, for example less than or equal to about 2.5 μm, for example less than or equal to about 2.0, for example less than or equal to about 1.8, for example less than or equal to about 1.7.

The value of d₉₉ for the particulate natural magnesium hydroxide according to the second aspect of the present invention is less than or equal to 20 μm, for example less than or equal to about 17 μm, for example less than or equal to about 15 μm, for example less than or equal to about 13 μm, for example less than or equal to about 11 μm, for example less than or equal to about 9 μm, for example less than or equal to about 7 μm, for example less than or equal to about 5 μm.

The value of d₅₀ for the particulate natural magnesium hydroxide according to the third aspect of the present invention is less than or equal to 6.0 μm, for example less than or equal to about 4.0 μm, for example less than or equal to about 2.0 μm, for example less than or equal to about 1.85 μm, for example less than or equal to about 1.75 μm, for example less than or equal to about 1.5 μ/m, for example less than or equal to about 1.4 μm, for example less than or equal to about 1.25 μm, for example less than or equal to about 1.0 μm, for example less than or equal to about 0.9 μm.

The present invention also provides particulate natural magnesium hydroxide having any physically possible combination of more than one of the values d₉₀, d₉₉ and d₅₀ as defined and described herein for the first, second and third aspects of the present invention.

The particulate natural magnesium hydroxide according to the present invention may typically have an ISO brightness of at least about 89, for example at least about 91, for example at least about 93.

The natural magnesium hydroxide according to the present invention can be used as such or the particles can be surface treated with one or more organic or inorganic treatment agent to impart or enhance particular characteristics of the natural magnesium hydroxide. The enhanced characteristics may include, for example, improved compatibility with the polymer matrix to improve mechanical properties, improved moisture resistance, reduced viscosity, reduced soluble soda content and electrical conductivity, and improved resistance to scratch whitening. For example, the particles can be treated in conventional manner with saturated or unsaturated fatty acids containing from 8 to 24 carbon atoms, such as, for example, oleic acid, palmitic acid, stearic acid, ammonium stearate, isostearic acid, lauric acid, or metal salts thereof, such as, for example, magnesium stearate, magnesium oleate, zinc stearate or zinc oleate. To increase compatibility with the polymer matrix, natural magnesium hydroxide can also be surface-treated with suitable coupling agents, such as, for example, organic silanes or titanates such as vinyltriethoxysilane, tri-(2-methoxyethoxy)vinylsilane, vinyltriacetylsilane, aminosilane, tetraisopropyltitanate, tetra-n-butyl-titanate, and the like. The particles can also be treated with phosphorous containing material, such as a phosphoric acid ester or salt thereof, for example stearyl alcohol phosphoric ester, lauryl alcohol phosphoric acid esters, or their sodium, potassium, ammonium, or amine salts (such as ethanol amine salts). The particles can also be treated with a phosphorous containing material comprising an alkylphosphonic acid, such as for example octylphosphonic acid, dodecylphosphonic acid.

Preparation of the Particulate Natural Magnesium Hydroxide or Filler Material

Coarse natural magnesium hydroxide is preferably crushed and coarsely ground using well known procedures, and then subjected to comminution to produce the particulate natural magnesium hydroxide or filler material according to the present invention. In one preferred embodiment, natural brucite may be crushed and dry ground to produce a flour-like material suitable as a feed for comminution to produce the particulate natural magnesium hydroxide or filler material according to the present invention.

Where it is desired to prepare a filler material in accordance with the fourth aspect of the invention, in which the particulate natural magnesium hydroxide is present with one or more other particulate inorganic material, the different materials may be processed together, e.g. for comminution, surface treatment, or both. Alternatively, the different material may also be blended together following comminution or surface treatment.

The comminution is preferably wet grinding or milling. Where grinding is used, it is preferably carried out in the presence of a suitable particulate grinding medium. The particulate grinding medium may be of a natural or a synthetic material. The grinding medium may comprise balls, beads or pellets of any hard mineral, ceramic or metallic material; such materials may include, for example, alumina, zirconia, zirconium, silicate, aluminium silicate or the mullite-rich material which is produced by calcining kaolinitic clay at a temperature in the range of from 1300° C. to 1800° C. Alternatively, particles of natural sand of a suitable particle size may be used. In one preferred embodiment, a sand or ceramic grinding medium is used in a wet grinding procedure, to achieve the desired particle size.

Generally, the type of, and particle size of, grinding medium to be selected for use in the invention may be dependent on the properties, such as, e.g. the particle size and the chemical composition of the feed of brucite to be ground. Preferably, the particulate grinding medium comprises particles having an average diameter in the range of from 0.1 mm to 6.0 mm and, more preferably in the range of from 0.2 mm to 4.0 mm. Preferably, the grinding medium (or media) may be present in an amount of from 40% to 70% by volume of the charge; more preferably in an amount of about 60% by volume of the charge.

The coarse brucite to be ground is preferably present in an aqueous suspension. In such a suspension, the coarse brucite may preferably be present in an amount of from 5% to 85% by weight of the suspension; more preferably in an amount of from 20% to 80% by weight of the suspension. Most preferably, the brucite may be present in an amount of about 30% to 75% by weight of the suspension. The energy input in a typical wet sandgrinding or ceramic-grinding process to obtain the desired particulate natural magnesium hydroxide or filler material according to the present invention may typically be in excess of about 20 kWh/tonne. The upper limit of energy input is generally difficult to specify, as the particle size will generally continue to reduce, albeit progressively more slowly, as the energy input is increased. Generally speaking, it should not be necessary for the energy input to exceed about 2000 kWh/tonne, in order to produce useful particulate natural magnesium hydroxide or filler material according to the present invention.

The suspension of solid material to be comminuted may be of a relatively high viscosity, in which case a dispersing agent may preferably be added to the suspension prior to comminution by the method of the invention. The dispersing agent may be, for example, a water soluble condensed phosphate, a water soluble salt of a polysilicic acid or a polyelectrolyte, for example a water soluble salt of a poly(acrylic acid) or of a poly(methacrylic acid) having a number average molecular weight not greater than 80,000. The amount of the dispersing agent used would generally be in the range of from 0.1 to 2.0% by weight, based on the weight of the dry particulate solid material. The suspension may suitably be ground at a temperature in the range of from 4° C. to 100° C.

The comminution is continued until the desired particle diameter is achieved, after which the particulate material is dewatered, dried and coated. Dewatering can be accomplished via use of settling bowls, dewatering centrifuges, plate and frame presses, belt presses, rotary vacuum filters, tube presses, high pressure presses, tangential flow membranes and evaporators or some combination thereof. Drying can be accomplished via use of spray driers, flash dryers, drum dryers, shelf or hearth dryers, freeze driers and drying mills, or some combination thereof. Coating can be performed using a combination of low and high energy mixing equipment.

Polymer

The polymer comprises any natural or synthetic polymer or mixture thereof. The polymer may, for example, be thermoplastic or thermoset. The term “polymer” used herein includes homopolymers and copolymers, blends, as well as crosslinked and/or entangled polymers and elastomers such as natural or synthetic rubbers and mixtures thereof. Specific examples of suitable polymers include, but are not limited to, polyolefins of any density such as polyethylene and polypropylene, polycarbonate, polystyrene, polyester, acrylonitrile-butadiene-styrene copolymer, nylons, polyurethane, ethylene-vinylacetate polymers, polyvinyl chloride, and any mixture thereof, whether cross-linked or un-cross-linked.

The term “precursor” as applied to the polymer component will be readily understood by one of ordinary skill in the art. For example, suitable precursors may include one or more of: monomers, cross-linking agents, curing systems comprising cross-linking agents and promoters, or any combination thereof.

The particulate inorganic filler is suitably present in the polymer composition according to the present invention in a flame retardant amount, suitably in an amount in the general loading range between about 5% and about 80% by weight, and more preferably between about 9% and about 50% by weight.

One or More Other Particulate Inorganic Material

The particulate natural magnesium hydroxide may be present—for example in the filler material as such or in the polymeric composition—with one or more other particulate inorganic material.

The other particulate inorganic material, when present, may, for example, be selected from phosphorus-containing compounds (e.g. organophosphates or phosphorus pentoxide), boron-containing compounds (e.g. boric acid and metal borates such as sodium borate, lithium metaborate, sodium tetraborate or zinc borate), metal salts, metal hydroxides (e.g. gibbsite, ground or precipitated alumina trihydroxide (ATH), synthetic magnesium hydroxide), metal oxides (e.g. lead dioxide, antimony oxide), hydrates thereof (e.g. sodium tetraborate decahydrate), mineral sources of any of the foregoing whether in native or at least partially refined form, organoclays (e.g. smectite clays such as bentonite, montmorillonoids such as montmorillonite, talc, pyrophilite, hectorite, vermiculite, perlite, saponite and ion-exchanged forms thereof, suitably ion-exchanged forms incorporating cations selected from quaternary ammonium and alkylimidazolium ions), kaolin clays, other non-kaolin clays (for example as described in Chapter 6 of “Clay Colloid Chemistry” by H. van Olphen, (Interscience, 1963); more specifically: one or more of; illites; other kaolinites such as dickite, nacrite and halloysite; chlorites; attapulgite and sepiolite), and any combination thereof, typically boric acid, a metal borate and any combination thereof.

The one or more other inorganic material may suitably have flame-retardant properties and be present with the particulate natural magnesium hydroxide in a flame-retardant amount. Preferred such components are ground and precipitated ATH.

Other Optional Components of the Filler Material or the Polymeric Composition

The filler material or the polymeric composition according to the present invention may include one or more other optional flame-retardant and/or non-flame-retardant components, preferably selected from conventional organic heat quenchers such as halogenated hydrocarbons (e.g. halogenated carbonate oligomers, halogenated phenyl oxides, halogenated alkylene-bis-phthalidimides and halogenated diglycyl ethers), optionally together with metal oxides (e.g. antimony oxide) and conventional additives for polymers, for example pigments, colorants, anti-degradants, anti-oxidants, impact modifiers (e.g. core-shell graft copolymers), fillers (e.g. talc, mica, wollastonite, glass or a mixture thereof), slip agents (e.g. erucamide, oleamide, linoleamide or steramide), coupling agents (e.g. silane coupling agents), peroxides, antistatic agents, mineral oils, stabilisers, flow enhancers, mould release agents (e.g. metal stearates such as calcium stearate and magnesium stearate), nucleating agents, clarifying agents, and any combination thereof.

Such components are suitably used in total amounts between about 1% and about 70% by total weight of the filler component, and more preferably between about 5% and about 50% by weight, e.g. up to about 30% by weight.

The coupling agent, where present, serves to assist binding of the filler particles to the polymer. Suitable coupling agents will be readily apparent to those skilled in the art. Examples include organic silanes or titanates such as vinyltriethoxysilane, tri-(2-methoxyethoxy)vinylsilane, vinyltriacetylsilane, tetraisopropyltitanate, tetra-n-butyl-titanate, and the like. The coupling agent is typically present in an amount of about 0.1% to about 2% by weight, preferably about 1% by weight, based on the weight of the total particulate filler.

Preparation of the Polymeric Composition

Preparation of the Polymeric Compositions of the Present Invention can be accomplished by any suitable mixing method known in the art, as will be readily apparent to one of ordinary skill in the art.

Such methods include dry blending of the individual components or precursors thereof and subsequent processing in conventional manner.

In the case of thermoplastic polymeric compositions, such processing may comprise melt mixing, either directly in an extruder for making an article from the composition, or pre-mixing in a separate mixing apparatus such as a Banbury mixer. Dry blends of the individual components can alternatively be directly injection moulded without pre-melt mixing.

The filler material according to the second aspect of the present invention can, where it includes more than one component, be prepared by mixing of the components thereof intimately together. The said filler material is then suitably dry blended with the polymer and any desired additional components, before processing as described above.

For the preparation of cross-linked or cured polymeric compositions, the blend of uncured components or their precursors will suitably be contacted under suitable conditions of heat, pressure and/or light with an effective amount of any suitable cross-linking agent or curing system, according to the nature and amount of the polymer used, in order to cross-link and/or cure the polymer.

For the preparation of polymeric compositions where the filler material is present in situ at the time of polymerisation, the blend of monomer(s) and any desired other polymer precursors, filler and any other component(s) will preferably be contacted under suitable conditions of heat, pressure and/or light, according to the nature and amount of the monomer(s) used, in order to polymerise the monomer(s) with the filler material and other component(s) in situ.

Articles

The polymeric compositions can be processed to form, or to be incorporated in, articles of commerce in any suitable way. Such processing may include compression moulding, injection moulding, gas-assisted injection moulding, calendering, vacuum forming, thermoforming, extrusion, blow moulding, drawing, spinning, film forming, laminating or any combination thereof. Any suitable apparatus may be used, as will be apparent to one of ordinary skill in this art.

The articles which may be formed from the compositions are many and various. Examples include sheaths for electrical cables, electrical cables coated or sheathed with the polymer composition, and housings and plastics components for electrical appliances (e.g. computers, monitors, printers, photocopiers, keyboards, pagers, telephones, mobile phones, hand-held computers, network interfaces, plenums and televisions).

### BRIEF DESCRIPTION OF THE DRAWINGS

The invention will now be described in more detail, but without limitation, with reference to the accompanying drawings, in which:

FIG. 1 shows a scanning electron micrograph (SEM) of the particles in the commercially available synthetic magnesium hydroxide Magnifin H5. The 1 micron (1 μm) scale is shown on the Figure. Magnifin H5 has a d₉₀ of about 3.15 μm, a d₅₀ of about 1.2-1.48 μm and a d₉₉ of about 6.7 μm.

FIG. 2 shows an SEM of the particles of a particulate ground natural magnesium hydroxide according to the present invention is shown. The 1 micron (1 μm) scale is shown on the Figure. This material has a d₉₀ of about 3.9 μm.

FIG. 3 shows a CILAS plot of cumulative percentage by volume of particles less than a given equivalent spherical diameter (ESD), against ESD, for a range of ground brucite samples, as described in more detail below and summarized in Table 1.

FIG. 4 shows a CILAS plot of cumulative percentage by volume of particles less than a given equivalent spherical diameter (ESD), against ESD, for several of the ground brucite samples and several commercial filler materials, as described in more detail below and summarized in Table 1.

### DETAILED DESCRIPTION OF THE DRAWINGS

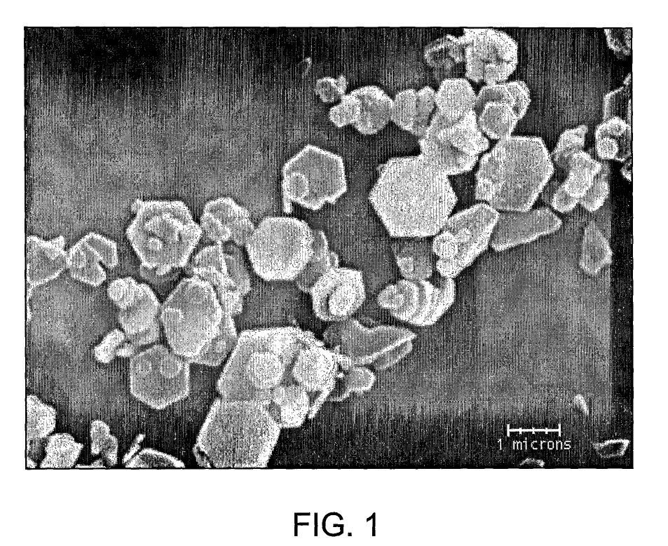

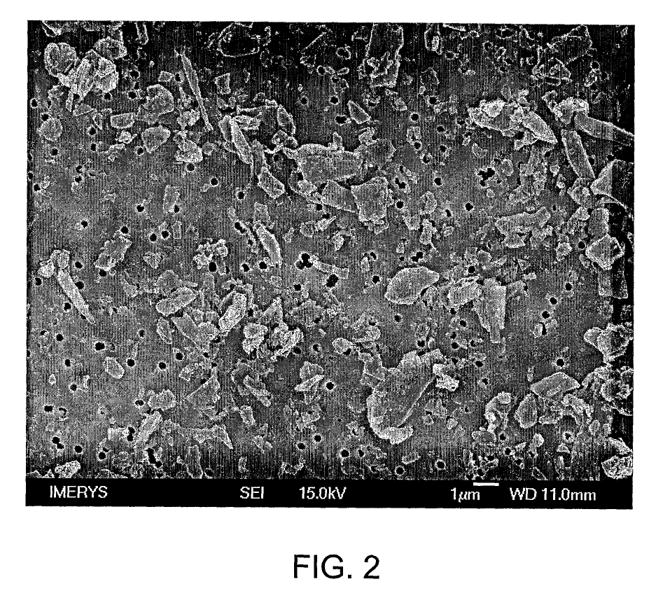

Referring to FIGS. 1 and 2 of the drawings, it will be noted that the material according to the present invention (FIG. 2) has highly irregular particle shapes, whereas the prior art synthetic particulate magnesium hydroxide has very regular (hexagonal) particle shapes (FIG. 1).

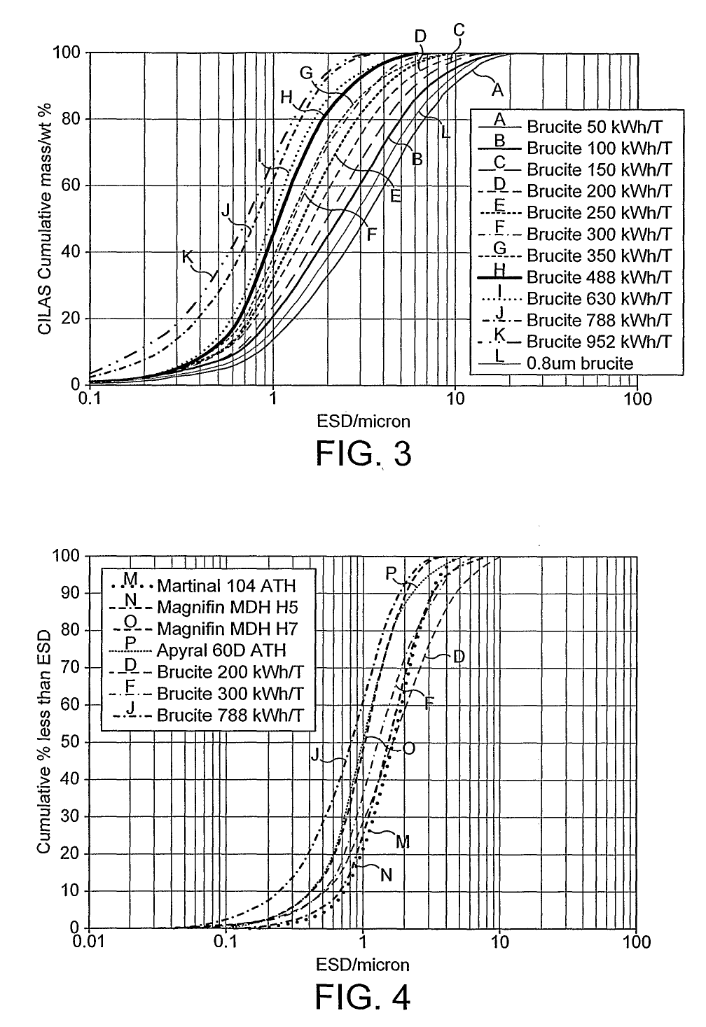

FIGS. 3 and 4 will be described in more detail in the following Example.

### EXAMPLE

### Method and Results

Brucite rocks about the size of standard house bricks were crushed using a Glen Creston Ltd 18-501 jaw crusher to produce brucite chips of about 20 mm or finer.

These chips were then milled in a Christy Norris disc mill to produce a coarse powder of a size of about 0.5 mm-0.25 mm or below. This powder was then passed through a Raymond Mill to produce a flour-like particulate brucite (75 wt % finer than 53 μm).

The flour-like material was made finer by wet milling by media grinding. The grinding media used was Carbolite 16-20, available from Carboceramics (www.carboceramics.com). This media is an aluminosilicate that is—16 mesh+20 mesh in particle size [i.e. at least 90% of the particles fall between the sieve sizes 16 mesh and 20 mesh (1180 μm and 850 μm)].

The brucite flour was made into a 22 wt % slurry (1224 g brucite flour+4322 g water). This was put into a polyurethane lined grinding pot (total capacity 15 litres). 13 kg of Carbolite 16-20 grade ceramic grinding media was added (equivalent to a 1:1 volume ratio with the slurry). A further slurry was prepared using 207.5 g brucite flour+732.5 g water+2.2 kg Carbolite in a 3 litre grinding pot.

Each pot containing the slurry and grinding media was put on the grinder where a four pronged impeller (each prong 15 cm in length) was inserted. The impeller tip speed of 512 rpm was kept constant throughout the milling process.

The amount of energy put into the slurry was measured indirectly using a calibrated load cell and integrator. A range of experiments was performed, with energy input ranging from approximately 50 to approximately 952 kWh/tonne, to yield twelve samples of ground brucite, labelled A to K.

After the desired amount of energy was put into the mineral the grinding pot was removed from the grinder and the Carbolite/brucite mixture was screened at 53 μm.

The brucite was washed from the Carbolite, using water, with the brucite passing through the 53 μm mesh.

The −53 μm brucite was then filtered on a Buchner filter at its natural pH of 10. A Whatman™ grade 50 filter paper was used. Once filtered the filtercake was then dried in an oven at 80° C.

The average particle size of each sample of ground brucite A to K was measured, using the CILAS technique previously described. In addition, CILAS particle size measurements were also obtained for a coarser natural ground brucite having a d90 of 8.1 for comparative purposes designated L. CILAS particle size measurements were also obtained for the commercially available flame retardant fillers designated M, N, O and P (M=Martinal 104 (particulate aluminium trihydrate, ATH), N=Magnifin MDH H5 (particulate synthetic magnesium hydroxide, MDH), 0=Magnifin MDH H7 (particulate synthetic magnesium hydroxide, MDH) and P=Apyral 60D (particulate aluminium trihydrate, ATH). The results are shown in Table 1 below. The CILAS plots are shown in FIGS. 3 and 4 of the drawings.

For the CILAS measurements of ground natural brucite samples, 55 g aqueous slurries were prepared, each containing approximately 8 g ground natural brucite (dry weight). The slurries were dispersed by addition of 1 ml of 10% w/v sodium hexametaphosphate and 0.2 to 0.3 g BTC2 (as received from the manufacturer M&J Polymers, Doncaster, United Kingdom). The samples were then stirred and sonicated for 60 seconds to disperse the particulate material before making particle size measurements using the CILAS 1064 instrument.

For the CILAS measurements of synthetic magnesium hydroxide samples, 3 g of the respective synthetic magnesium hydroxide was suspended in 50 ml water and 5 ml of sodium polyacrylate dispersant (1.5% active in water). The samples were then stirred and sonicated for 60 seconds to disperse the particulate material before making particle size measurements using the CILAS 1064 instrument.

TABLE 1

| | | | | Read from PSD data as | | |
|---|---|---|---|---|---|---|
| Sample | Data from CILAS Measurement | | | obtained by CILAS | | |
| No. | d50/μm | d10/μm | D90/μm | d95/μm | d99/μm | d100/μm |
| A | 3.13 | 0.83 | 9.29 | 12.0 | 16.5 | 23 |
| B | 2.24 | 0.64 | 6.84 | 9.2 | 13.5 | 18 |
| C | 1.92 | 0.61 | 5.72 | 7.8 | 10.7 | 15 |
| D | 1.62 | 0.52 | 4.73 | 6.3 | 9.0 | 12 |
| E | 1.42 | 0.51 | 3.96 | 5.2 | 7.3 | 10 |
| F | 1.26 | 0.50 | 3.41 | 4.2 | 5.6 | 8 |
| G | 1.22 | 0.46 | 3.34 | 4.4 | 6.7 | 10 |
| H | 1.06 | 0.45 | 2.56 | 3.3 | 4.8 | 6 |
| I | 0.97 | 0.41 | 2.26 | 3.1 | 4.6 | 6 |
| J | 0.80 | 0.24 | 1.79 | 2.2 | 3.0 | 4 |
| K | 0.70 | 0.18 | 1.68 | 2.1 | 2.8 | 4 |
| L | 2.66 | 0.74 | 8.10 | 10.4 | 14.1 | 18 |
| M | 1.61 | 0.72 | 3.09 | 3.6 | 4.6 | 6 |
| N | 1.50 | 0.66 | 3.15 | 4.1 | 6.7 | 10 |
| 0 | 1.01 | 0.41 | 2.03 | 2.4 | 3.1 | 4 |
| P | 0.97 | 0.41 | 2.25 | 3.1 | 4.6 | 6 |

The relationship between the approximate energy input and the resultant d₅₀ (as measured by CILAS) is shown in Table 2 below:

TABLE 2

| | Energy Input | CILAS |
|---|---|---|
| Sample No. | kWh/tonne | d₅₀/μm |
| A | 50 | 3.13 |
| B | 100 | 2.24 |
| C | 150 | 1.92 |
| D | 200 | 1.62 |
| E | 250 | 1.42 |
| F | 300 | 1.26 |
| G | 350 | 1.22 |
| H | 488 | 1.06 |
| I | 630 | 0.97 |
| J | 788 | 0.80 |
| K | 952 | 0.70 |

### Brightness and Tint

The ISO brightness, CIE brightness, and tint of two samples of the ground brucite designated J in the above tests was measured via standard procedures with a D65-6500 K illuminant, 10 degrees observation, and with UV excluded (no fluorescence). Results are shown in Table 3 below where VIO is the ISO brightness, and L* the CIE brightness:

TABLE 3

| Sample | VIO | YEL | L* | a* | b* |
|---|---|---|---|---|---|
| J1 | 93.7 | 0.9 | 97.8 | −0.09 | 0.60 |
| J2 | 93.9 | 0.9 | 97.9 | −0.12 | 0.63 |

### CONCLUSION

The natural ground brucite prepared in accordance with the present invention has particle size and optical properties suitable for use as fire retardant filler in polymeric applications, such as fire retardant cable sheathing. The present invention thus makes available a cheaper acceptable alternative to conventional synthetic polymer fillers.

The present invention has been described broadly and without limitation to specific embodiments. Variations and modifications as will be readily apparent to those of ordinary skill in this art are intended to be included within the scope of this application and subsequent patent(s).

1-56. (canceled)

57. Particulate natural magnesium hydroxide having a d₉₀ less than or equal to 6.2 μm as measured by CILAS.

58. Particulate natural magnesium hydroxide according to claim 57, having a d₉₀ less than or equal to about 5.0 μm as measured by CILAS.

59. Particulate natural magnesium hydroxide according to claim 58, having a d₉₀ less than or equal to about 4.0 μm as measured by CILAS

60. Particulate natural magnesium hydroxide according to claim 59, having a d₉₀ less than or equal to about 3.0 μm as measured by CILAS.

61. Particulate natural magnesium hydroxide according to claim 60, having a d₉₀ less than or equal to 2.0 μm as measured by CILAS.

62. Particulate natural magnesium hydroxide according to claim 57, further having a d₉₉ less than or equal to 20 μm as measured by CILAS.

63. Particulate natural magnesium hydroxide according to claim 62, further having a d₉₉ less than or equal to about 15 μm as measured by CILAS.

64. Particulate natural magnesium hydroxide according to claim 63, further having a d₉₉ less than or equal to about 9 μm as measured by CILAS.

65. Particulate natural magnesium hydroxide according to claim 64, further having a d₉₉ less than or equal to about 5 μm as measured by CILAS.

66. Particulate natural magnesium hydroxide according to claim 57, further having a d₅₀ less than or equal to about 4.0 μm as measured by CILAS.

67. Particulate natural magnesium hydroxide according to claim 66, further having a d₅₀ less than or equal to about 2.0 μm as measured by CILAS.

68. Particulate natural magnesium hydroxide according to claim 67, further having a d₅₀ less than or equal to about 1.5 μm as measured by CILAS.

69. Particulate natural magnesium hydroxide according to claim 68, further having a d₅₀ less than or equal to about 1.0 μm as measured by CILAS.

70. Particulate natural magnesium hydroxide according to claim 57, wherein the particles are surface-treated with one or more surface-treatment agents.

71. Particulate natural magnesium hydroxide according to claim 70, wherein the surface-treatment agent is selected from: saturated or unsaturated fatty acids containing from 8 to 24 carbon atoms, metal salts of saturated or unsaturated fatty acids containing from 8 to 24 carbon atoms, and coupling agents.

72. Particulate natural magnesium hydroxide according to claim 71, wherein the saturated or unsaturated fatty acids are chosen from oleic acid, palmitic acid, stearic acid, isostearic acid, and lauric acid.

73. Particulate natural magnesium hydroxide according to claim 71, wherein the metal salts are chosen from ammonium stearate, magnesium stearate, magnesium oleate, zinc stearate, and zinc oleate.

74. Particulate natural magnesium hydroxide according to claim 71, wherein the coupling agents are chosen from organic silanes and titanates.

75. Particulate natural magnesium hydroxide according to claim 74, wherein the organic silanes are chosen from vinyltriethoxysilane, tri-(2-methoxyethoxy)vinylsilane, vinyltriacetylsilane, and aminosilane.

76. Particulate natural magnesium hydroxide according to claim 74, wherein the titanates are chosen from tetraisopropyltitanate and tetra-n-butyl-titanate.

77. A process for preparing particulate natural magnesium hydroxide having a d₉₀ less than or equal to 6.2 μm as measured by CILAS, wherein brucite is ground in an aqueous suspension in the presence of at least one particulate grinding medium under conditions such that the energy input is in excess of about 20 kWh/tonne.

78. A polymeric composition comprising a polymer and a filler material comprising particulate natural magnesium hydroxide having a d₉₀ less than or equal to 6.2 μm as measured by CILAS, and optionally one or more other particulate inorganic materials.

79. Particulate natural magnesium hydroxide according to claim 57, having an ISO brightness of at least about 89.

80. Particulate natural magnesium hydroxide according to claim 79, having an ISO brightness of at least about 91.

81. Particulate natural magnesium hydroxide according to claim 80, having an ISO brightness of at least about 93.
